(19) United States
(12) Patent Application Publication
(10) Pub. No.: US 2020/0053842 A1
(43) Pub. Date: Feb. 13, 2020

(54) CONVECTION COOKING APPLIANCE AND REMOVABLE UTENSIL FOR AIR FRYING

(71) Applicant: Haier US Appliance Solutions, Inc., Wilmington, DE (US)

(72) Inventors: Woong Jeon, Hwaseong (KR); Younki Min, Yongin (KR)

(21) Appl. No.: 16/100,292

(22) Filed: Aug. 10, 2018

(51) Int. Cl. H05B 6/64; A47J 37/06; H05B 6/68; B65D 81/34

(52) U.S. Cl. CPC H05B 6/6473; B65D 81/3453; H05B 6/687; A47J 37/0641

(57) ABSTRACT

A convection cooking appliance and removable utensil for air frying within the convection cooking appliance is provided herein. The utensil may include a utensil housing, a lid attached to the utensil housing, and a perforated basket. The utensil housing may define an enclosed fry chamber and a basket opening permitting access thereto. The utensil housing may include a non-permeable base wall and a sidewall. The sidewall may define an airflow passage to receive a convection airflow therethrough. The lid may be movable between a closed position restricting access to the basket opening and an open position permitting access to the basket opening. The perforated basket may be removably positioned within the enclosed fry chamber.

### FIELD OF THE INVENTION

The present subject matter relates generally to cooking appliances, such as ovens, and more particularly to cooking appliances and utensils for air frying within a cooking appliance.

### BACKGROUND OF THE INVENTION

Frying foods has been a common cooking method across many cultures. By applying oil and high levels of heat to a food item, frying induces the Maillard effect such that a crispy layer is formed on the outside of the food item, while the inside portion of the food item remains moist and unburnt. In traditional methods, this requires submerging food items completely in hot oil. Although foods cooked by these traditional methods may have achieved a satisfactory taste, they also have significant drawbacks. For instance, due to being submerged with oil, it is common for fried food items to assume a soggy texture. Moreover, it is becoming well-recognized that such methods also lead to the fried food items being relatively unhealthful. Frying food items by traditional methods can also be cumbersome and hazardous. Oil can spill or splatter, causing significant burns or damage.

In recent years, alternative methods of cooking and frying have been pursued. In particular, the popularity of air frying has increased significantly. Whereas traditional methods require submerging food within oil, air frying methods only require a thin layer of oil to be coated on top of the food items. After being coated, the food items are typically placed within a relatively small and dedicated appliance. Within the appliance, hot air is often circulated at high speeds about the food items via a convection mechanism. The reaction of oil to the hot air induces the Maillard effect on the food items without ever submerging the food items in oil.

While dedicated air frying appliances (i.e., air fryers) can be attractive for their safety and health benefits, they often present their own drawbacks. For instance, the user must find space for and learn how to operate a completely new appliance. As with many single-purpose cooking appliances, the specialization of an air fryer may lead to its nonuse.

It would be useful to provide a utensil or appliance that addressed one or more of the above issues. In particular, it would be advantageous to have a utensil or appliance, such as an oven appliance, that could be used not only for air frying methods, but other common cooking methods as well (e.g. baking, broiling, etc.).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking utensil is provided. The cooking utensil may include a utensil housing, a lid attached to the utensil housing, a perforated basket, and a gasket. The utensil housing may define an enclosed fry chamber and a basket opening permitting access thereto. The utensil housing may include a non-permeable base wall and a sidewall. The sidewall may define an airflow passage to receive a convection airflow therethrough. The lid may be movable between a closed position restricting access to the basket opening and an open position permitting access to the basket opening. The perforated basket may be removably positioned within the enclosed fry chamber. The gasket may be positioned about the airflow passage to sealingly engage an inner wall of a convection oven appliance.

In another exemplary aspect of the present disclosure, an oven appliance is provided. The oven appliance may include a cabinet, a convection fan, and a cooking utensil. The cabinet may include an inner wall defining a cooking chamber for receipt of food items for cooking. The inner wall may further define a fan opening therethrough. The convection fan may be mounted within the cabinet in fluid communication with the fan opening. The cooking utensil may be selectively mated to the inner wall within the cooking chamber. The cooking utensil may include a utensil housing, a lid attached to the utensil housing, and a perforated basket. The utensil housing may define an enclosed fry chamber and a basket opening permitting access thereto. The utensil housing may include a non-permeable base wall and a sidewall. The sidewall may define an airflow passage aligned with the fan opening to receive a convection airflow therethrough. The lid may be movable between a closed position restricting access to the basket opening and an open position permitting access to the basket opening. The perforated basket may be removably positioned within the enclosed fry chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to exemplary embodiments of the present disclosure.

FIG. 2 provides a cross-sectional side view of the exemplary oven appliance of FIG. 1 along the line 2-2.

FIG. 3 provides a schematic side view of a cooking appliance according to exemplary embodiments of the present disclosure, wherein the oven appliance is shown performing a cooking operation without an air frying cooking utensil therein.

FIG. 4 provides a schematic side view of the exemplary cooking appliance of FIG. 3, wherein the oven appliance is shown performing a cooking operation with an air frying cooking utensil therein.

FIG. 5 provides a schematic view of an inner wall portion of a cooking appliance according to exemplary embodiments of the present disclosure.

FIG. 6 provides a schematic view of the exemplary oven appliance of FIG. 5, wherein an air frying cooking utensil has been attached to the inner wall.

FIG. 7 provides a front perspective view of an air frying cooking utensil according to exemplary embodiments of the present disclosure.

FIG. 8 provides a rear perspective view of the exemplary air frying cooking utensil of FIG. 7.

FIG. 9 provides a front perspective view of the exemplary air frying cooking utensil of FIG. 7, wherein a perforated basket has been removed from a utensil body.

FIG. 10 provides a rear perspective view of the exemplary air frying cooking utensil of FIG. 7, wherein a perforated basket has been removed from a utensil body.

FIG. 11 provides a schematic side view of an air frying cooking utensil attached to an oven appliance according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

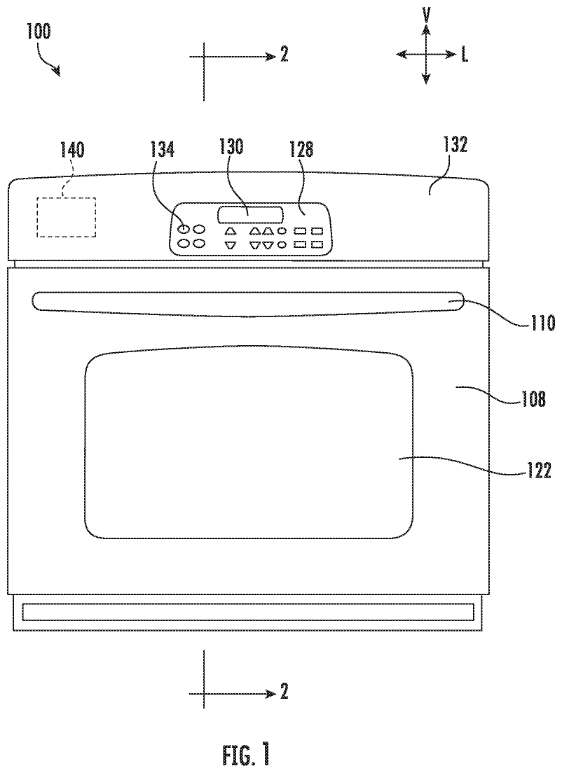

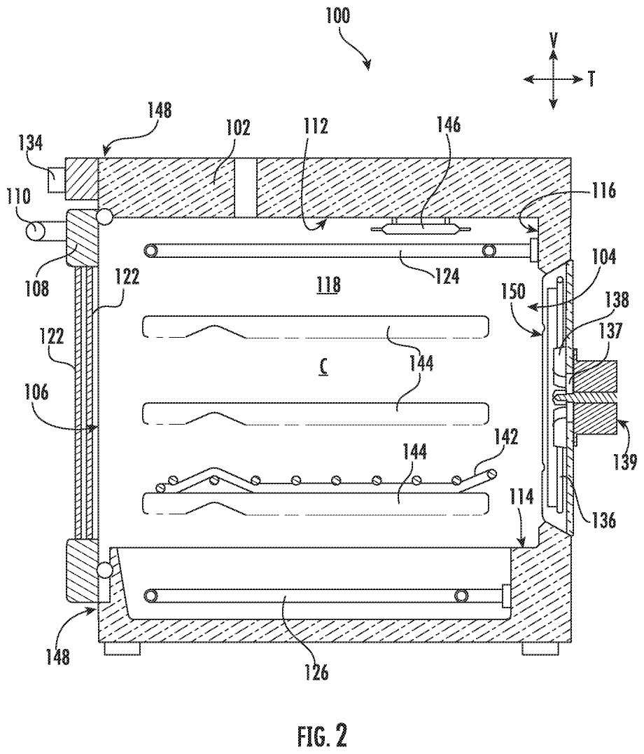

Referring to FIGS. 1 and 2, in exemplary embodiments, a cooking appliance or oven appliance 100 that includes an insulated cabinet 102 with an interior cooking chamber 104 defined by a plurality of inner walls (e.g., a top wall 112, a bottom wall 114, a back wall 116, and opposing sidewalls 118, 120). Cooking chamber 104 is configured for the receipt of one or more food items to be cooked. Oven appliance 100 includes a door 108 pivotally mounted, for example, with one or more hinges (not shown), to cabinet 102 at the opening 106 of cabinet 102 to permit selective access to cooking chamber 104 through opening 106. A handle 110 is mounted to door 108 and assists a user with opening and closing door 108. For example, a user can pull on handle 110 to open or close door 108 and access cooking chamber 104.

In some embodiments, a seal (e.g., gasket) is provided between door 108 and cabinet 102 that assists with maintaining heat and cooking fumes within cooking chamber 104 when door 108 is closed, as shown in FIGS. 1 and 2. Multiple parallel glass panes 122 provide for viewing the contents of cooking chamber 104 when door 108 is closed and assist with insulating cooking chamber 104. A baking rack 142 is positioned in cooking chamber 104 for the receipt of food items or utensils containing food items. Baking rack 142 is slidably received onto embossed ribs or sliding rails 144 such that rack 142 may be conveniently moved into and out of cooking chamber 104 when door 108 is open.

A heating element at the top, bottom, or both of cooking chamber 104 provides heat to cooking chamber 104 for cooking. Such heating element(s) can be gas, electric, microwave, or a combination thereof. For example, in the embodiment shown in FIG. 2, oven appliance 100 includes a top heating element 124 and a bottom heating element 126, where bottom heating element 126 is positioned adjacent to and below bottom wall 114. Other configurations with or without wall 114 may be used as well.

In some embodiments, oven appliance 100 includes a convection heating element 136 and convection fan 138 positioned adjacent back wall 116 of cooking chamber 104 (e.g., in fluid communication with cooking chamber 104 through a fan opening 150). Convection fan 138 is powered by a convection fan motor 139. Further, convection fan 138 can be a variable speed fan. Thus, the speed (e.g., rotation speed) of fan 138 may be controlled or set anywhere between and including, for example, 0 and 100 percent. In certain embodiments, oven appliance 100 includes a bidirectional triode thyristor (not shown) [i.e., a triode for alternating current (triac)] to regulate the operation of convection fan 138 such that the speed of fan 138 may be adjusted during operation of oven appliance 100 (e.g., during a preheat or cooking cycle). Optionally, speed of convection fan 138 can be determined by, and communicated to, fan 138 by controller 140. In addition, a sensor 137, such as a rotary encoder, a Hall effect sensor, or the like, may be included at the base of fan 138, for example, between fan 138 and motor 139 as shown in the exemplary embodiment of FIG. 2, to sense the speed of fan 138. The speed of fan 138 may be measured in, for example, revolutions per minute (“RPM”).

As shown, oven appliance 100 includes a user interface 128. In some embodiments, user interface 128 has a display 130 positioned on an interface panel 132, as well as a variety of controls 134. Interface 128 allows the user to select various options for the operation of oven 100 including, for example, temperature, time, and various cooking or cleaning cycles. Operation of oven appliance 100 can be regulated by a controller 140 that is operatively coupled (i.e., in communication with) user interface 128, heating elements 124, 126, and other suitable components of oven 100.

In certain embodiments, in response to user manipulation of the user interface 128, controller 140 can operate the heating element(s). Controller 140 can receive measurements from a temperature sensor 146 placed in cooking chamber 104 and, optionally, provide a temperature indication to the user with display 130.

In some embodiments, controller 140 includes a memory (e.g., non-transitive media) and one or more processing devices such as microprocessors, CPUs, or the like, such as general or special purpose microprocessors operable to execute programming instructions or micro-control code associated with operation of oven appliance 100. The memory may represent random access memory such as DRAM or read only memory such as ROM or FLASH. In one embodiment, the processor executes programming instructions stored in memory. The memory may be a separate component from the processor or may be included onboard within the processor.

Controller 140 may be positioned in a variety of locations throughout oven appliance 100. In the illustrated embodiment, controller 140 is located next to user interface 128 within interface panel 132. In other embodiments, controller 140 may be located under or next to the user interface 128 otherwise within interface panel 132 or at any other appropriate location with respect to oven appliance 100. In the embodiment illustrated in FIG. 1, input/output (“I/O”) signals are routed between controller 140 and various operational components of oven appliance 100 such as heating elements 124, 126, 136, convection fan 138, controls 134, display 130, sensor 146, alarms, or other components as may be provided. In one embodiment, user interface 128 may represent a general purpose I/O (“GPIO”) device or functional block.

Although shown with touch type controls 134, it should be understood that controls 134 and the configuration of oven appliance 100 shown in FIG. 1 is provided by way of example only. More specifically, user interface 128 may include various input components, such as one or more of a variety of electrical, mechanical, or electro-mechanical input devices including rotary dials, push buttons, and touch pads. User interface 128 may include other display components, such as a digital or analog display device designed to provide operational feedback to a user. User interface 128 may be in communication with controller 140 via one or more signal lines or shared communication busses.

While oven 100 is shown as a wall oven, the present invention could also be used with other cooking appliances or configurations such as, for example, a double-chamber oven appliance, a stand-alone oven appliance, a combined oven-range appliance, or other configurations of such ovens.

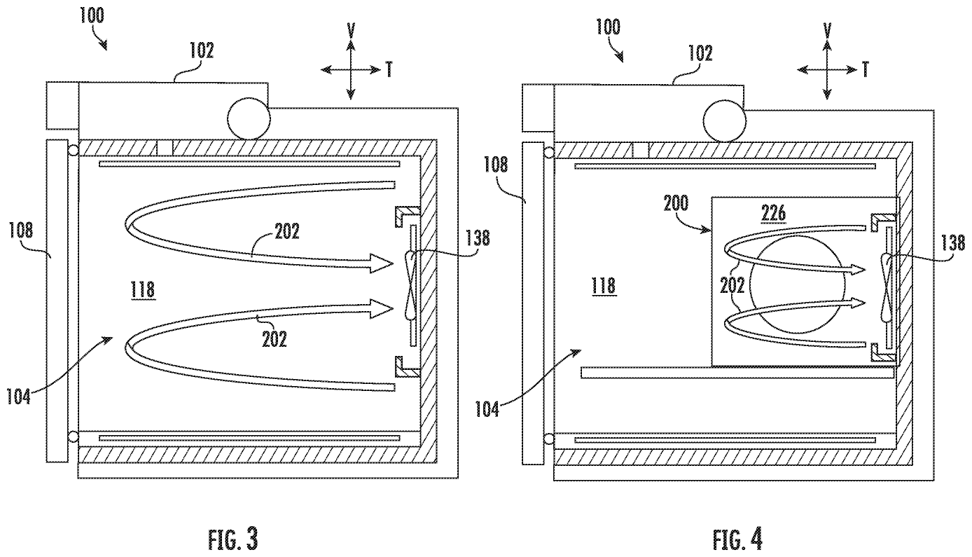

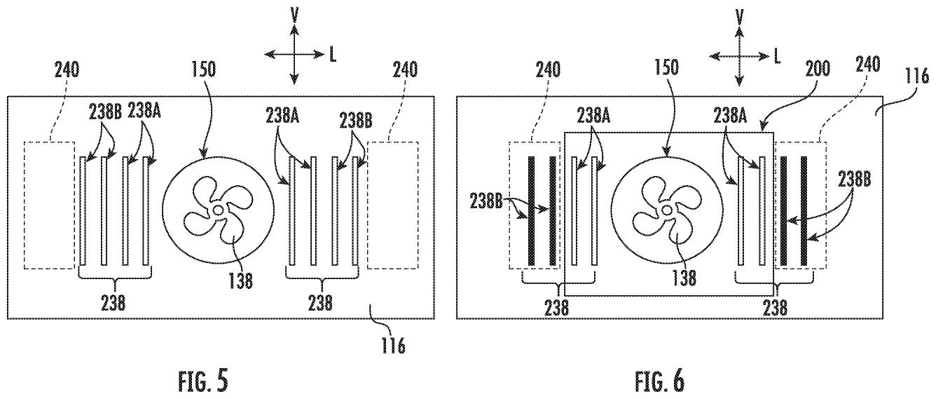

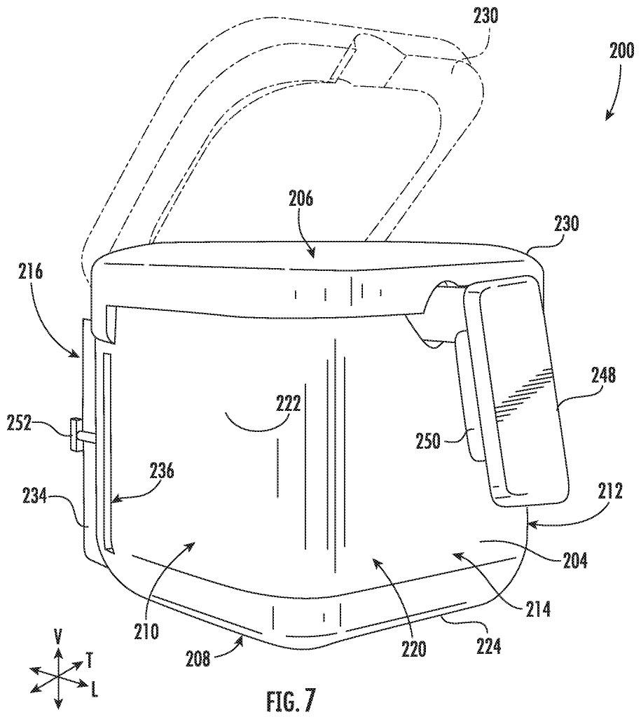

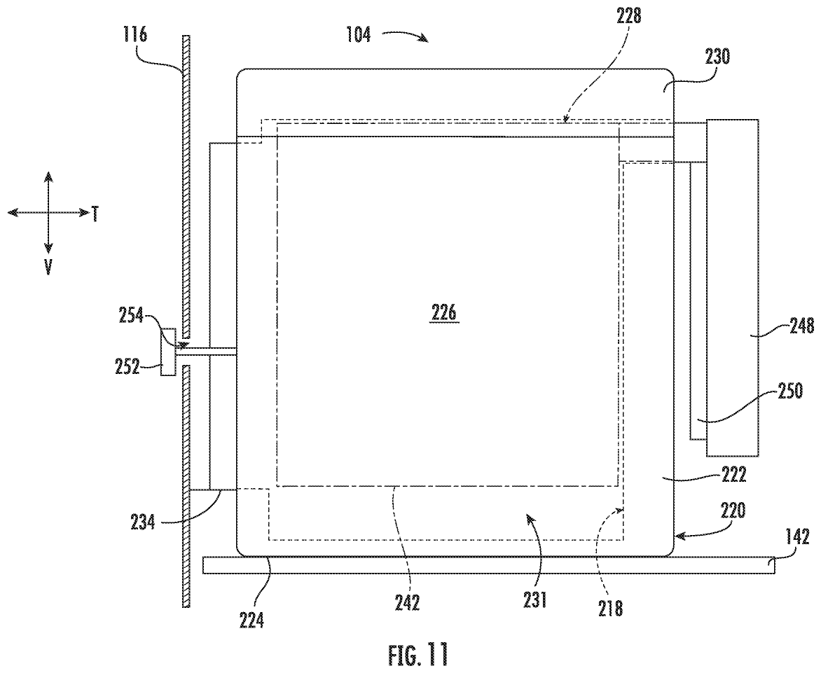

Turning now generally to FIGS. 3 through 11, FIGS. 3 through 6 provide various views of an exemplary oven appliance 100 both without (FIGS. 3 and 5) and with (FIGS. 4, 6, and 11) a removable cooking utensil 200 (e.g., air frying utensil) mounted therein. FIGS. 7 through 10 provide various perspective views of cooking utensil 200 in isolation (i.e., outside of oven appliance 100).

As shown, and as will be discussed in greater detail below, cooking utensil 200 is selectively attachable within cooking chamber 104 of oven appliance 100. In certain embodiments, cooking utensil 200 is selectively mated to a predetermined inner wall (e.g., back wall 116) of cabinet 102. At least a portion of the airflow (e.g., as indicated at arrows 202) from convection fan 138 may thus be contained or restricted within cooking utensil 200 when it is attached or mounted within cooking chamber 104.

Generally, cooking utensil 200 includes a utensil housing 204 extending in the vertical direction V between a top end 206 and a bottom end 208; in the lateral direction L between a first side 210 and a second side 212; and in the transverse direction T between a front side 210 and a rear side 216. Together, the vertical direction V, lateral direction L, and transverse direction T defines a mutually orthogonal coordinate system. As used in the context of cooking utensil 200 specifically, it is understood that the vertical direction V, lateral direction L, transverse direction T may correspond to the same directions defined by cabinet 102 when cooking utensil 200 is mounted within cooking chamber 104. However, is further understood that as a selectively attachable (i.e., removable) assembly, cooking utensil 200 is independently movable relative to cabinet 102 and thus defines its own mutually orthogonal coordinate system.

Utensil housing 204 includes an interior surface 218 and an opposite exterior surface 220 (e.g., along a base wall 224 and one or more sidewalls 222 extending upward therefrom). Thus, utensil housing 204 may include a nonpermeable base wall 224 and one or more sidewalls 222. Utensil housing 204 may be formed from any suitable nonpermeable material, such a rigid heat-tolerant metal or polymer. When assembled, interior surface 218 is directed toward, and may generally define, an enclosed fry chamber 226. By contrast, exterior surface 220 is directed outward or away from enclosed fry chamber 226. For instance, when cooking utensil 200 is mounted within cooking chamber 104, exterior surface 220 may generally face the door 108 and inner walls (e.g., side wall 118 and back wall 116) of cooking appliance 100.

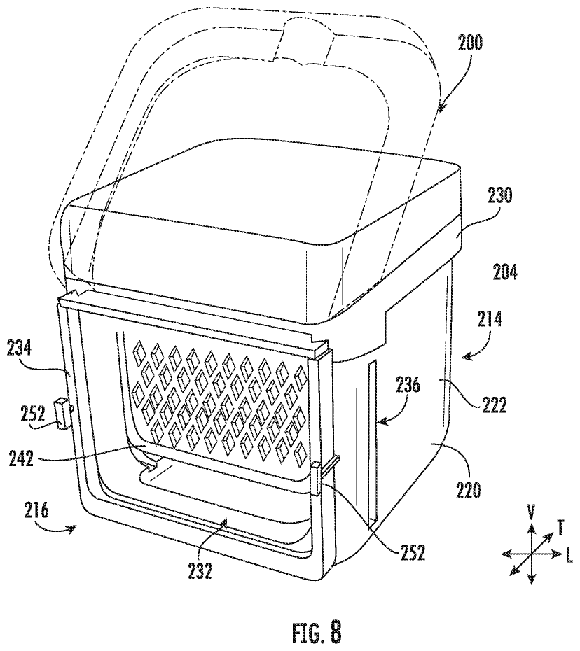

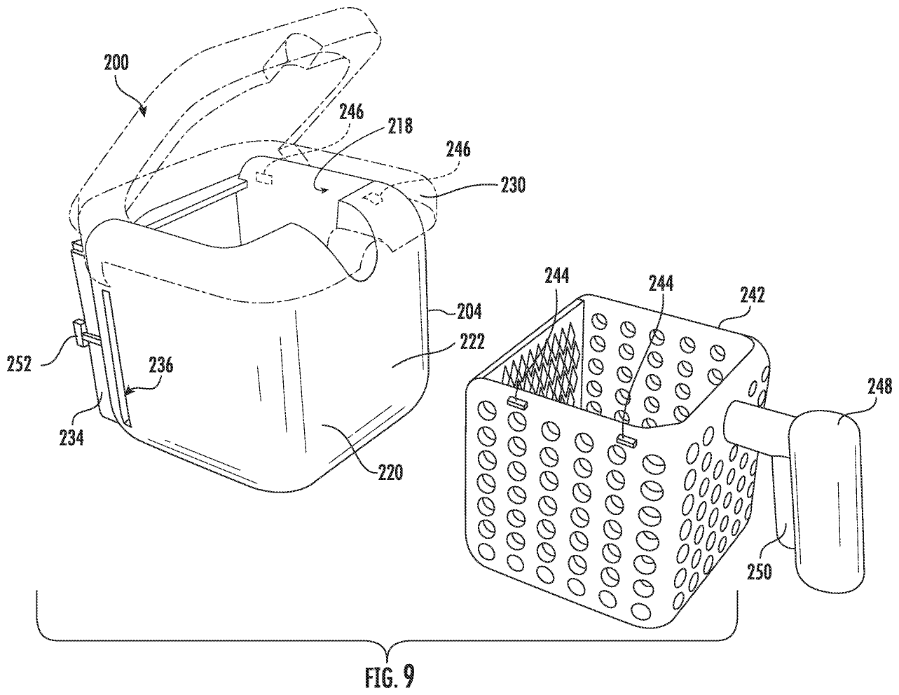

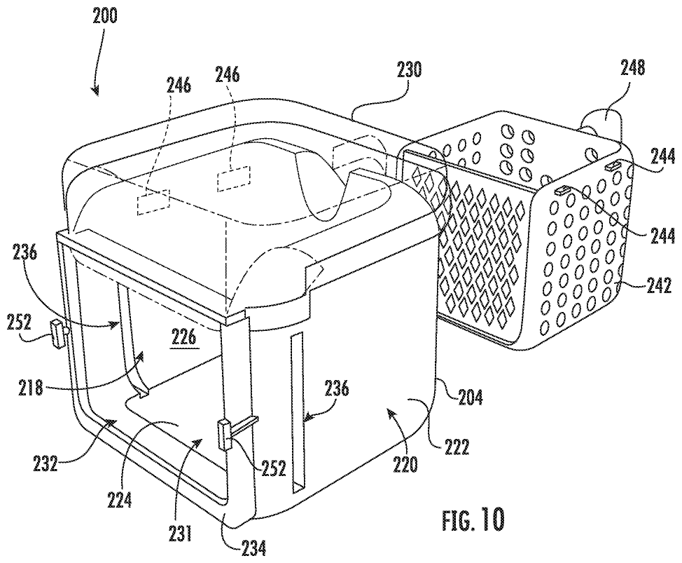

A basket opening 228 is defined through utensil housing 204 to permit access to and communication with enclosed fry chamber 226. In exemplary embodiments, basket opening 228 is defined at top end 206. For instance, the plurality of sidewalls 222 may define basket opening 228 as a vertical aperture or void directly above and in fluid communication with enclosed fry chamber 226. A lid 230 may be attached to utensil housing 204 to selectively cover or close basket opening 228. In some such embodiments, lid 230 is attached (e.g., rotatably attached) to utensil housing 204 (e.g., at rear side 216 or top end 206). As illustrated, lid 230 may be movable between a closed position (e.g., FIGS. 7 and 8) and an open position (e.g., FIGS. 9 and 10, as well as in phantom lines in FIG. 7). In the closed position, lid 230 may restrict access to basket opening 228. For instance, lid 230 may fit over top end 206 of utensil housing 204 and span all or some of the horizontal cross-sectional area defined by basket opening 228. By contrast, in the open position, they may permit access to basket opening 228. For instance, lid 230 may be tilted or moved entirely away from utensil housing 204 such that basket opening 228 is generally unobstructed (e.g., in the vertical direction V).

In some embodiments, at least one sidewall 222 of utensil housing 204 defines an airflow passage 232. For instance, airflow passage 232 may be defined through a sidewall 222 at rear side 216 of utensil housing 204 (e.g., along the transverse direction T). Thus, airflow passage 232 may extend through a sidewall 222 from interior surface 218 to exterior surface 220 in fluid communication with enclosed fry chamber 226. When cooking utensil 200 is mounted or selectively attached to cabinet 102, airflow passage 232 may be aligned (e.g., along the transverse direction T) with a fan opening 150 defined through the inner wall to which utensil housing 204 is attached (e.g., back wall 116). In a fully mounted position, airflow passage 232 is thus in fluid communication between enclosed fry chamber 226 and convection fan 138 (e.g., to receive a convection airflow). During use, air motivated by convection fan 138 may be circulated through enclosed fry chamber 226 before being returned to fan opening 150 or expelled through a portion of utensil housing 204.

As shown, a sealing member or gasket 234 may be positioned about airflow passage 232. In particular, gasket 234 is attached or fixed to a sidewall 222 adjacent to airflow passage 232. Gasket 234 may extend horizontally (e.g., along the transverse direction T) from exterior surface 220. Additionally or alternatively, gasket 234 may circumferentially bound airflow passage 232 such that gasket 234 encircles the perimeter of airflow passage 232 (e.g., in the vertical direction V and the lateral direction L). When cooking utensil 200 is mounted or attached to back wall 116, gasket 234 may engage or contact back wall 116 and form a seal (e.g., hermetic seal) therewith. Optionally, gasket 234 may surround the fan opening 150 and direct conductive airflow therefrom. As is understood, gasket 234 may be formed from any suitable material such as an elastic high-temperature rubber.

In certain embodiments, utensil housing 204 further defines one or more air vent slots 236 spaced apart from airflow passage 232. As an example, a pair of opposite air vent slots 236 may be defined at first side 210 and second side 212, respectively. Each air vent slot 236 may extend from interior surface 218 to exterior surface 220. In other words, each air vent slot 236 may extend completely through its respective sidewall 222. Optionally, each air vent slot 236 may be proximal to rear side 216 (i.e., closer to rear side 216 than front side 214 along the transverse direction T). During use, a portion of the active airflow from convection fan 138 may thus be circulated through enclosed fry chamber 226 before being released through air vent slots 236 to cooking chamber 104 of oven appliance 100.

In additional or alternative embodiments, utensil housing 204 defines an oil reservoir 231 in fluid communication with enclosed fry chamber 226. In particular, oil reservoir 231 may be defined directly beneath enclosed fry chamber 226 (e.g., along the vertical direction V). For instance, base wall 224 may provide or define a recess within which will may be collected. Oil reservoir 231 may be further positioned below airflow passage 232 or air vent slots 236 (e.g., along the vertical direction V) such that fluid within oil reservoir 231 is contained within an area of utensil housing 204 that is lower than airflow passage 232 or air vent slots 236. Oil from enclosed fry chamber 226 (or food items therein) may thus flow or drip from enclosed fry chamber 226 to oil reservoir 231 without passing to airflow passage 232, air vent slots 236, or cooking chamber 104.

Turning especially to FIGS. 5 and 6, in some embodiments, the inner wall to which cooking utensil 200 attaches (e.g., back wall 116) may define one or more secondary openings 238 in addition to fan opening 150. As shown, secondary openings 238 may be spaced apart from fan opening 150 in a direction perpendicular to the direction of airflow from fan opening 150. For instance, secondary openings 238 may be spaced apart from fan opening 150 in the lateral direction L or the vertical direction V. Generally, each of secondary openings 238 extend fully through the respective inner wall (e.g., along the transverse direction T through back wall 116) and may be in fluid communication with convection fan 138. In certain embodiments, a plurality of secondary openings 238 are defined through back wall 116 spaced apart from fan opening 150 and each other along the lateral direction L. When attached to back wall 116, cooking utensil 200 may enclose fan opening 150 and one or more inner openings 238A adjacent to fan opening 150 while outer openings 238B distal to fan opening 150 are spaced apart from cooking utensil 200.

In some such embodiments, a shutter 240 is movably mounted to back wall 116 to selectively close block one or more secondary openings 238. For instance, shutter 240 may be movable (e.g. slidable along the lateral direction L or vertical direction V) across outer openings 238B between an open position (FIG. 5) and a closed position (FIG. 6). In the open position, outer openings 238B may be unblocked and fluid communication may be permitted between convection fan 138 and the cooking chamber 104 through outer openings 238B. In the closed position, shutter 240 may cover or block outer openings 238B and restrict fluid communication between convection fan 138 and cooking chamber 104 through outer openings 238B.

Returning generally to FIGS. 4 through 11, cooking utensil 200 is generally configured to hold or include a perforated basket 242 within utensil housing 204. In particular, perforated basket 242 may be removably positioned within enclosed fry chamber 226 (e.g., to hold or support food items therein). Removal or insertion of perforated basket 242 may be performed by the user by moving perforated basket 242 along the vertical direction V through basket opening 228. Optionally, one or more adjustable retractable prongs 244 may extend radially (e.g., along the lateral direction L) from perforated basket 242 to engage a portion of sidewall 222 (e.g., at interior surface 218). For instance, interior surface 218 may define one or more mating grooves 246 that generally correspond in shape and relative position to retractable prongs 244. In some such embodiments, when perforated basket 242 is received within enclosed fry chamber 226 each retractable prong 244 may be received within and engage a discrete mating groove 246.

In certain embodiments, a handle 248 extends from perforated basket 242 (e.g., in fixed attachment thereto). Generally, handle 248 may provide a surface or elements for a user to engage or grab, for instance, when removing or inserting perforated basket 242 from enclosed fry chamber 226. In some embodiments, handle 248 is held outside of enclosed fry chamber 226 when perforated basket 242 is received within enclosed fry chamber 226. As an example, when perforated basket 242 is received within enclosed fry chamber 226 handle 248 may extend through a sidewall 222 (e.g., at front side 214 of utensil housing 204) such that a grip portion of handle 248 is spaced apart from exterior surface 220 and outside of enclosed fry chamber 226.

In optional embodiments, a user engageable lever 250 is provided on handle 248. Lever 250 may be in mechanical communication with another portion of cooking utensil 200 besides handle 248. For instance, lever 250 may be mechanically linked with retractable prongs 244 such that engaging or squeezing lever 250 releases or retracts prongs 244 (e.g., in disengages retractable prongs 244 from mating grooves 246). As is understood, an internal gear or tension assembly may connect lever 250 to retractable prongs 244, thereby ensuring movement of retractable prongs 244 in response to the engagement of lever 250.

In additional or alternative embodiments, one or more connector tabs 252 may extend from utensil housing 204. In particular, connector tabs 252 may extend from exterior surface 220 of sidewall 222 to selectively attach utensil housing 204 with inner wall (e.g., back wall 116). For instance, connector tabs 252 may extend along the transverse direction T at rear side 216 of cooking utensil 200 (e.g., past gasket 234). Optionally, a pair of connector tabs 252 may be provided on opposite lateral ends of airflow passage 232. In other words, one connector tab 252 may be proximal to first side 210 while another connector tab 252 may be proximal to second side 212. When attached, connector tabs 252 may extend through at least a portion of, for example, back wall 116. A tab aperture 254 may be defined through back wall 116 to receive connector tabs 252.

As shown, connector tabs 252 may include an enlarged head or flange held apart from exterior surface 220 by a relatively small body. In some such embodiments the body of each connector tabs 252 extends through, for example, back wall 116 such that the enlarged head or flange is held on one side of back wall 116 while utensil housing 204 is held on the opposite side of back wall 116 and within cooking chamber 104. Each tab may be rotatable about a corresponding pivot axis. Each pivot axis may be perpendicular to the vertical direction V (e.g., parallel to the transverse direction T). In optional embodiments handle 248 is configured to rotate the plurality of connector tabs 252. As is understood, the gear or transfer assembly may connect handle 248 with the plurality of connector tabs 252 (e.g., when perforated basket 242 is received within enclosed fry chamber 226) such that rotation of handle 248 is transferred to connector tabs 252. Rotation of handle 248 may thus cause connector tabs 252 to rotate within tab aperture 254 (e.g., such that a portion of the enlarged head is unable to pass through tab aperture 254 and transverse movement of utensil housing 204 is restricted).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking utensil selectively attachable within a cooking chamber of a convection oven appliance, the cooking utensil comprising:
a utensil housing defining an enclosed fry chamber and a basket opening permitting access thereto, the utensil housing comprising a non-permeable base wall and a sidewall, the sidewall defining an airflow passage to receive a convection airflow therethrough;
a lid attached to the utensil housing, the lid being movable between a closed position restricting access to the basket opening and an open position permitting access to the basket opening;
a perforated basket removably positioned within the enclosed fry chamber; and
a gasket positioned about the airflow passage to sealingly engage an inner wall of the convection oven appliance.

2. The cooking utensil of claim 1, wherein the utensil housing further defines an oil reservoir in fluid communication with the enclosed fry chamber below the perforated basket.

3. The cooking utensil of claim 1, wherein the sidewall of the utensil housing comprises an interior surface directed toward the enclosed fry chamber and an exterior surface directed away from the enclosed fry chamber, and wherein the cooking utensil further comprises a handle extending in fixed attachment from the perforated basket through the sidewall from the interior surface to the exterior surface.

4. The cooking utensil of claim 1, further comprising a plurality of retractable prongs extending radially from the perforated basket in selective engagement with the sidewall of the utensil housing.

5. The cooking utensil of claim 1, wherein the sidewall of the utensil housing comprises an interior surface directed toward the enclosed fry chamber and an exterior surface directed away from the enclosed fry chamber, and wherein the cooking utensil further comprises a plurality of connector tabs extending from exterior surface of the sidewall to engage the inner wall of the convection oven appliance in selective attachment.

6. The cooking utensil of claim 5, wherein each connector tab of the plurality of connector tabs is rotatable about a corresponding pivot axis parallel to a transverse direction.

7. The cooking utensil of claim 5, wherein the plurality of connector tabs comprises a pair of connector tabs on opposite lateral ends of the airflow passage.

8. The cooking utensil of claim 1, wherein the sidewall utensil housing defines an air vent slot extending therethrough and spaced apart from the airflow passage.

9. An oven appliance defining a mutually-orthogonal vertical direction, lateral direction, and transverse direction, the oven appliance comprising:
a cabinet, the cabinet comprising an inner wall defining a cooking chamber for receipt of food items for cooking, the inner wall further defining a fan opening therethrough;
a convection fan mounted within the cabinet in fluid communication with the fan opening; and
a cooking utensil selectively mated to the inner wall within the cooking chamber, the cooking utensil comprising
a utensil housing defining an enclosed fry chamber and a basket opening permitting access thereto, the utensil housing comprising a non-permeable base wall and a sidewall, the sidewall defining an airflow passage aligned with the fan opening to receive a convection airflow therethrough,
a lid attached to the utensil housing, the lid being movable between a closed position restricting access to the basket opening and an open position permitting access to the basket opening, and
a perforated basket removably positioned within the enclosed fry chamber.

10. The oven appliance of claim 9, wherein the cooking utensil further comprises a gasket positioned about the airflow passage in sealing engagement with the inner wall of the oven appliance.

11. The oven appliance of claim 9, wherein the utensil housing further defines an oil reservoir in fluid communication with the enclosed fry chamber below the perforated basket.

12. The oven appliance of claim 9, wherein the sidewall of the utensil housing comprises an interior surface directed toward the enclosed fry chamber and an exterior surface directed away from the enclosed fry chamber, and wherein the cooking utensil further comprises a handle extending in fixed attachment from the perforated basket through the sidewall from the interior surface to the exterior surface.

13. The oven appliance of claim 9, further comprising a plurality of retractable prongs extending radially from the perforated basket in selective engagement with the sidewall of the utensil housing.

14. The oven appliance of claim 9, wherein the sidewall of the utensil housing comprises an interior surface directed toward the enclosed fry chamber and an exterior surface directed away from the enclosed fry chamber, and wherein the cooking utensil further comprises a plurality of connector tabs extending from exterior surface of the sidewall in selective attachment with the inner wall.

15. The oven appliance of claim 14, wherein each connector tab of the plurality of connector tabs is rotatable about a corresponding pivot axis parallel to a transverse direction.

16. The oven appliance of claim 14, wherein the plurality of connector tabs comprises a pair of connector tabs on opposite lateral ends of the airflow passage.

17. The oven appliance of claim 9, wherein the sidewall utensil housing defines an air vent slot extending therethrough and spaced apart from the airflow passage.

18. The oven appliance of claim 9, wherein the inner wall further defines a secondary opening extending therethrough between the convection fan and the cooking chamber, wherein the secondary opening is spaced apart from the fan opening, and wherein the oven appliance further comprises a shutter selectively movable across the secondary opening between an open position and a closed position, the open position permitting fluid communication between the convection fan and the cooking chamber through the secondary opening, and the closed position restricting fluid communication between the convection fan and the cooking chamber through the secondary opening.
